(19) United States
(12) Patent Application Publication
(10) Pub. No.: US 2018/0222163 A1
(43) Pub. Date: Aug. 9, 2018

(54) Mold Inhibiting Package and Associated Methods for Fabricating and Packaging

(71) Applicant: Wal-Mart Stores, Inc., Bentonville, AR (US)

(72) Inventor: Charles W. Rutledge, Springdale, AR (US)

(21) Appl. No.: 15/869,458

(22) Filed: Jan. 12, 2018

Related U.S. Application Data
(60) Provisional application No. 62/455,682, filed on Feb. 7, 2017.

(51) Int. Cl. B32B 27/08; A23K 30/00; A23K 40/30; B32B 27/28; B32B 27/18

(52) U.S. Cl. CPC B32B 27/08; A23K 30/00; A23K 40/30; B32B 2307/7145; B32B 27/18; B32B 2439/70; B32B 27/285

(57) ABSTRACT

An example mold inhibiting package and associated methods are described. The mold inhibiting package includes walls formed from an outer layer affixed to an inner layer with the inner layer being in contact with the product. At least one of the outer layer or the inner layer is infused with a mold inhibitor during formation of the respective outer layer or inner layer. The mold inhibitor activates at a predetermined temperature or humidity level to prevent mold formation within an inner chamber of the package.

### CROSS-REFERENCE TO RELATED APPLICATIONS

This application claims the benefit of co-pending, commonly assigned U.S. Provisional Patent Application No. 62/455,682, which was filed on Feb. 7, 2017. The entire content of the foregoing provisional patent application is incorporated herein by reference.

### BACKGROUND

Perishable products are packaged and sold in a variety of retail establishments each day. These perishable products may be intended for humans or their pets. Sometimes these products include an expiration date for the product.

### SUMMARY

Exemplary embodiments of the present invention provide a mold inhibiting package that includes a mold inhibitor infused into the walls of the package to prevent mold formation within an inner chamber of the package. The walls of the mold inhibiting package include an outer layer affixed to an inner layer. At least one of the outer layer or the inner layer is infused with the mold inhibitor during formation of the respective outer layer or inner layer. The mold inhibitor activates at a predetermined temperature and/or humidly level to prevent mold formation within the inner chamber of the mold inhibiting package.

In one embodiment, an exemplary mold inhibiting package includes an inner layer having an inner surface configured to be in contact with a product, an outer layer affixed to the inner layer, and an inner chamber formed by sealing walls created by the affixing of the outer layer to the inner layer. The inner chamber is configured and dimensioned to receive a product. At least one of the outer layer or the inner layer is infused with a mold inhibitor during formation of the respective outer layer or inner layer. The mold inhibitor activates at a predetermined temperature or humidity level to prevent mold formation within the inner chamber.

In an embodiment, a method of fabricating a mold inhibiting packaging includes forming an outer layer and an inner layer of the mold inhibiting packaging. The method includes infusing at least one of the outer layer or the inner layer with a mold inhibitor during formation of the respective outer layer or inner layer. The method includes forming walls of the mold inhibiting packaging by affixing the outer layer to the inner layer. The inner layer has an inner surface configured to be in contact with a product. The method also includes sealing the walls to form an inner chamber configured and dimensioned to receive the product. The mold inhibitor activates at a predetermined temperature or humidity level to prevent mold formation within the inner chamber.

In an embodiment, a method of packaging a product includes providing a mold inhibiting package. The method additionally includes introducing a product into a mold inhibiting packaging. The mold inhibiting packaging includes walls sealed to form an inner chamber configured and dimensioned to receive the product. The walls are formed from an outer layer affixed to an inner layer. The inner layer has an inner surface configured to be in contact with the product. The method also includes closing the mold inhibiting packaging. At least one of the outer layer or the inner layer is infused with a mold inhibitor during formation of the respective outer layer or inner layer. The mold inhibitor activates at a predetermined temperature or humidity level to prevent mold formation within the inner chamber.

It should be appreciated that combinations and/or permutations of embodiments are envisioned as being within the scope of the present invention. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed mold inhibiting package and associated methods, reference is made to the accompanying figures. The accompanying figures, which are incorporated in and constitute a part of this specification, illustrate one or more embodiments of the invention and, together with the description, help to explain the invention. In the figures:

FIG. 1 is a diagrammatic perspective view of an exemplary mold inhibiting package in an embodiment.

FIG. 2 is a diagrammatic, cross-sectional view of an exemplary mold inhibiting package in an embodiment.

FIG. 3 is a flowchart illustrating a process of fabricating an exemplary mold inhibiting package in accordance with an embodiment.

FIG. 4 is a flowchart illustrating a process of packaging a product in accordance with an embodiment.

### DETAILED DESCRIPTION

It should be understood that the relative terminology used herein, such as “front”, “rear”, “left”, “top”, “bottom”, “vertical”, “horizontal”, “up” and “down” is solely for the purposes of clarity and designation and is not intended to limit embodiments to a particular position and/or orientation. Accordingly, such relative terminology should not be construed to limit the scope of the present invention. In addition, it should be understood that the scope of the present invention is not limited to embodiments having specific dimensions. Thus, any dimensions provided herein are merely for an exemplary purpose and are not intended to limit the invention to embodiments having particular dimensions.

Although packages of perishable products that are being sold may include an expiration date for the product, expiration of such products can depend on the temperature and humidity levels in which the packaged product is stored. Depending on the temperature and/or humidity levels, mold formation within a package can lead to earlier than expected expiration of the product. Exemplary embodiments of the present invention provide a mold inhibiting package that includes a mold inhibitor infused into the walls of the package to prevent mold formation within an inner chamber of the package. The walls of the mold inhibiting package include an outer layer affixed to an inner layer. At least one of the outer layer or the inner layer is infused with the mold inhibitor during formation of the respective outer layer or inner layer. The mold inhibitor activates at a predetermined temperature and/or humidly level to prevent mold formation within the inner chamber of the mold inhibiting package.

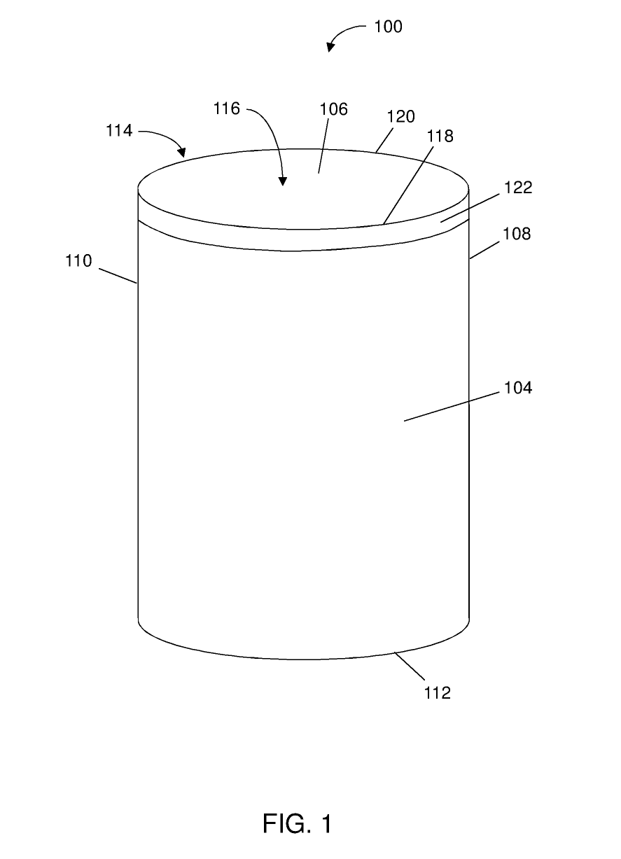

FIG. 1 is a diagrammatic perspective view of an exemplary mold inhibiting package 100 (hereinafter “package 100”) in accordance with exemplary embodiments. The package 100 generally includes a front wall 104 and a rear wall 106. The front and rear walls 104, 106 can be sealed to each other to form side edges 108, 110 and a bottom edge 112 of the package 100. The package 100 includes an opening 114 through which a product (e.g., an edible product, such as dog food) can be introduced into an inner chamber 116 of the package 100. In particular, the opening 114 can be formed between the top edges 118, 120 of the front and rear walls 104, 106.

In an embodiment, rather than including two walls sealed together, the package 100 can include a single, substantially continuous wall sealed together along the bottom edge 112 to form the inner chamber 116. In an embodiment, the package 100 can include two or more walls sealed together along respective edges to form the inner chamber 116. After the product has been introduced into the inner chamber 116, the top edges 118, 120 are sealed to prevent contamination of contents of the inner chamber 116 during transport of the package 100 to a retail establishment.

In an embodiment, after the package 100 has been opened by a consumer to reveal the opening 114, the top edges 118, 120 can be closed via clips for storage of the package 100. In an embodiment, the package 100 can include a sealing or closure mechanism 122 at or near the top edges 118, 120 to allow the top edges 118, 120 to be repeatedly closed for storage of the package 100. The closure mechanism 122 is capable of being in an open position or a closed position. In an embodiment, the closure mechanism 122 can be in the form of a ZIPLOC® or VELCRO® mechanism disposed along the inner surface of the top edges 118, 120.

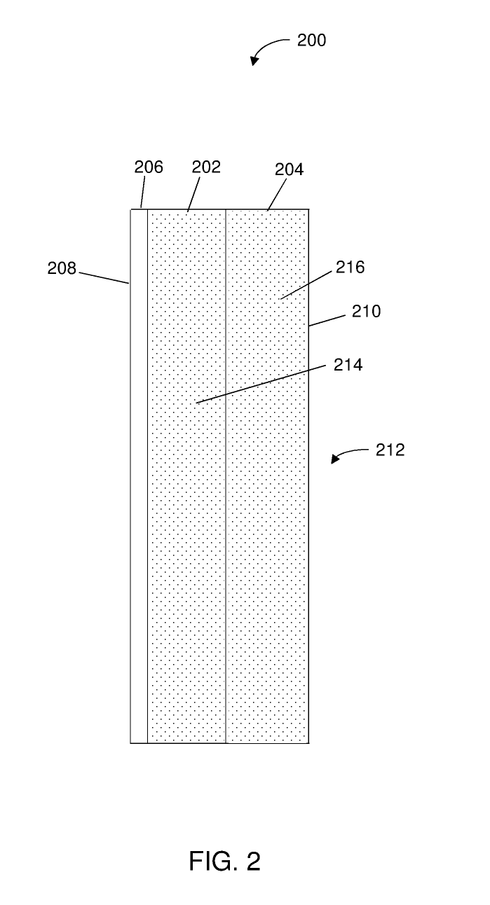

FIG. 2 is a diagrammatic, cross-sectional view of a wall 200 of the package 100 (e.g., the front or rear wall 104, 106). In particular, FIG. 2 illustrates the structure of each of the walls 200 of the package 100. The wall 200 includes an outer layer 202 affixed or secured to an inner layer 204. In an embodiment, the outer layer 202 can be fused to the inner layer 204 (e.g., with laminate adhesive, or the like). In an embodiment, the wall 200 can include a layer 206 affixed or secured to the outer layer 202 (e.g., a paint or laminate layer with graphics). In an embodiment, the inner layer 204 can be a polypropylene mesh. In an embodiment, the outer layer 202 can be a reverse-printed polyethylene film laminated to the inner layer 204.

An outer surface 208 of the outer layer 202 (or the layer 206 if the layer 206 is included in the structure of the wall 200) defines the surface visible to the consumer which is not in contact with the product within the package 100. The inner layer 204 defines an inner surface 210 configured to be in contact with the product. In particular, the inner surface 210 faces the inner chamber 212 within the package 100. In an embodiment, the inner layer 204 is infused with a mold inhibitor 216 that assists in preventing or mitigating mold formation within the inner chamber 212.

In an embodiment, the outer layer 202 is infused with a mold inhibitor 214 during formation of the outer layer 202. Alternatively, in an embodiment, the inner layer 204 is infused with a mold inhibitor 216 during formation of the inner layer 204. In another embodiment, both the outer layer 202 and the inner layer 204 are infused with the respective mold inhibitor 214, 216 during formation of the outer layer 202 and inner layer 204. In an embodiment, the mold inhibitor 214, 216 can be infused into the outer layer 202 and/or inner layer 204 on a molecular level during formation of the respective outer layer 202 and/or inner layer 204. For example, the mold inhibitor 214, 216 can be in the form of a pelletized additive melted together with a resin during formation of the respective outer layer 202 and/or inner layer 204. As a further example, the mold inhibitor 214, 216 can be in the form of ⅛ inch diameter pellets added to a resin during formation of the respective outer layer 202 and/or inner layer 204. It should be appreciated that other techniques not specifically discussed herein may also be used to infuse the mold inhibitor 214, 216 into the outer and/or inner layer 202, 204 without departing from the scope of the present invention.

The mold inhibitor 214, 216 activates at a predetermined temperature and/or humidity level to prevent or mitigate mold formation within the inner chamber 212, thereby preventing spoilage of the product within the package 100. For example, upon reaching a predetermined temperature and/or humidity level, at least a portion of the mold inhibitor 214, 216 can be released from the outer layer 202 and/or the inner layer 204 by passing through the respective outer layer 202 and/or inner layer 204 and into the inner chamber 212. The outer surface 208 can be formed from a material that prevents the mold inhibitor 214, 216 from passing out of the outer surface 208 to the exterior environment outside the package 100, thereby guiding the mold inhibitor 214, 216 in the direction of the inner chamber 212. In an embodiment, the activated mold inhibitor 214, 216 provides desiccant-like behavior to remove moisture from the inner chamber 212 to prevent feeding of the mold, thereby preventing mold growth within the inner chamber 212 while also creating a chemical reaction that actively kills mold spores to prevent their replication.

In an embodiment, the predetermined temperature at which the mold inhibitor 214, 216 is activated can be equal to or above approximately 70° F. In an embodiment, the predetermined temperature and/or humidity at which the mold inhibitor 214 of the outer layer 202 activates can be different from the predetermined temperature and/or humidity at which the mold inhibitor 216 of the inner layer 204 activates, thereby allowing for a multi-stage release of the mold inhibitor 214, 216.

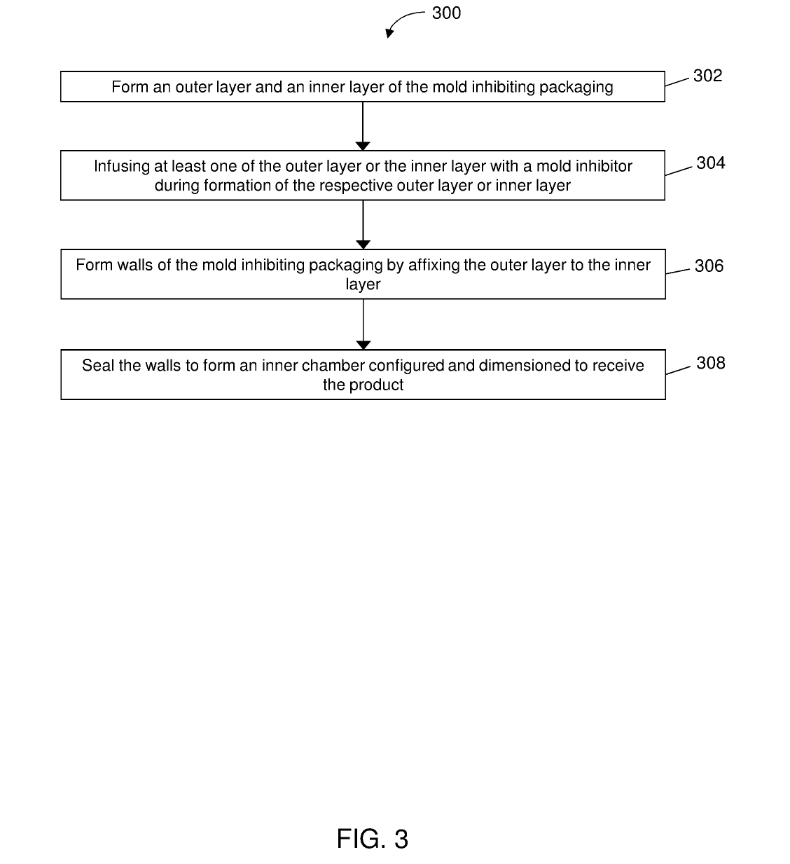

FIG. 3 is a flowchart illustrating an exemplary process 300 of fabricating a mold inhibiting packaging. To begin, at step 302, an outer layer and an inner layer of the mold inhibiting packaging are formed. At step 304, at least one of the outer layer or the inner layer is infused with a mold inhibitor during formation of the respective outer layer or inner layer. The mold inhibitor activates at a predetermined temperature or humidity level to prevent mold formation within the inner chamber of the mold inhibiting packaging. In an embodiment, the outer layer and/or the inner layer can be infused with the mold inhibitor on a molecular level during formation of the respective outer layer and/or inner layer.

At step 306, the walls of the mold inhibiting packaging are formed by affixing the outer layer to the inner layer. In an embodiment, the outer layer can be fused to the inner layer. The inner layer has an inner surface configured to be in contact with the packaged product. At step 308, the walls are sealed to form the inner chamber configured and dimensioned to receive the product, such as, for example, dog food.

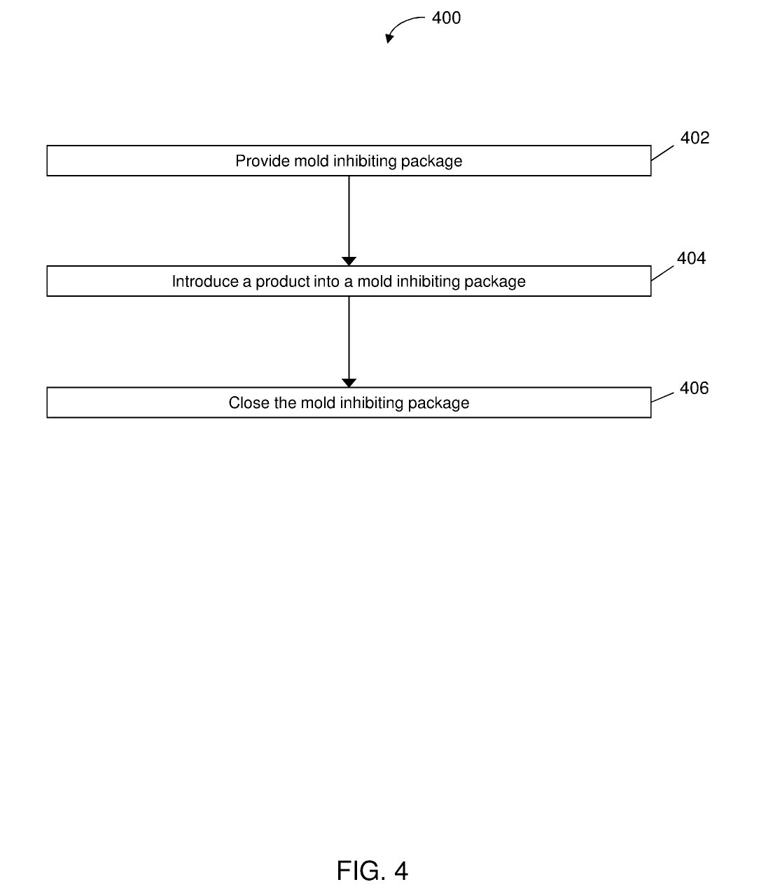

FIG. 4 is a flowchart illustrating an exemplary process 400 of packing a product. To begin, at step 402, a mold inhibiting package is provided, for example a mold inhibiting package formed as described herein. At step 404 the product is introduced into a mold inhibiting packaging, as described herein. In particular, the mold inhibiting packaging includes walls formed from an outer layer and an inner layer, at least one of the outer layer or the inner layer being infused with a mold inhibitor. At step 406, the mold inhibiting package is closed or sealed for transport to a retail establishment.

Thus, the exemplary mold inhibiting package prevents and mitigates mold formation within the inner chamber during storage of the product. For example, during fluctuations in temperature and/or humidity in the storage location of the product, the mold inhibitor activates to prevent and mitigate mold formation within the packaging. Expiration of the product can thereby be delayed, ensuring a more satisfied customer.

In another embodiment, instead of the mold inhibitor being infused into the outer or inner layer the mold inhibitor may be sprayed or applied as a coating to the inner layer. Alternatively, in a further embodiment, the mold inhibitor may be provided via an adhesive component affixed to the inner layer.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A mold inhibiting package, comprising:
an inner layer having an inner surface configured to be in contact with a product;
an outer layer affixed to the inner layer; and
an inner chamber formed by sealing walls created by the affixing of the outer layer to the inner layer, the inner chamber configured and dimensioned to receive a product;
wherein at least one of the outer layer or the inner layer is infused with a mold inhibitor during formation of the respective outer layer or inner layer, the mold inhibitor activating at a predetermined temperature or humidity level to prevent mold formation within the inner chamber.

2. The mold inhibiting package of claim 1, wherein the product is an edible product.

3. The mold inhibiting package of claim 1, wherein the outer layer is fused to the inner layer.

4. The mold inhibiting package of claim 1, wherein the mold inhibitor is infused into the outer layer or the inner layer on a molecular level during formation of the respective outer layer or inner layer.

5. The mold inhibiting package of claim 1, wherein the outer layer is infused with the mold inhibitor during formation of the outer layer.

6. The mold inhibiting package of claim 5, wherein the mold inhibitor activates and passes through the inner layer and into the inner chamber at the predetermined temperature or humidity to prevent mold formation within the inner chamber.

7. The mold inhibiting package of claim 1, wherein the inner layer is infused with the mold inhibitor during formation of the outer layer.

8. The mold inhibiting package of claim 7, wherein the mold inhibitor activates and passes out of the inner layer and into the inner chamber at the predetermined temperature or humidity to prevent mold formation within the inner chamber.

9. The mold inhibiting package of claim 1, including an opening formed between the walls for introduction of the product into the inner chamber.

10. The mold inhibiting package of claim 9, comprising a closure mechanism associated with the opening and capable of being in an open position or a closed position.

11. The mold inhibiting package of claim 1, comprising a mold inhibiting coating disposed on at least a portion of the inner layer.

12. The mold inhibiting package of claim 1, wherein the mold inhibitor is an additive added during formation of the respective outer layer or inner layer.

13. The mold inhibiting package of claim 1, wherein the inner layer is a polypropylene mesh.

14. The mold inhibiting package of claim 1, wherein the outer layer is a reverse-printed polyethylene film laminated to the inner layer.

15. The mold inhibiting package of claim 1, wherein the predetermined temperature is equal to or above 70° F.

16. A method of fabricating a mold inhibiting packaging, comprising:
forming an outer layer and an inner layer of the mold inhibiting packaging;
infusing at least one of the outer layer or the inner layer with a mold inhibitor during formation of the respective outer layer or inner layer;
forming walls of the mold inhibiting packaging by affixing the outer layer to the inner layer, the inner layer having an inner surface configured to be in contact with a product; and
sealing the walls to form an inner chamber configured and dimensioned to receive the product,
wherein the mold inhibitor activates at a predetermined temperature or humidity level to prevent mold formation within the inner chamber.

17. The method of claim 16, further comprising:
fusing the outer layer to the inner layer.

18. The method of claim 16, further comprising:
infusing the mold inhibitor into the outer layer or the inner layer on a molecular level during formation of the respective outer layer or inner layer.

19. A method of packaging a product, comprising:
providing a mold inhibiting package;
introducing a product into the mold inhibiting package, the mold inhibiting package including walls sealed to form an inner chamber configured and dimensioned to receive the product, the walls formed from an outer layer affixed to an inner layer, the inner layer having an inner surface configured to be in contact with the product, and
closing the mold inhibiting package,
wherein at least one of the outer layer or the inner layer is infused with a mold inhibitor during formation of the respective outer layer or inner layer, the mold inhibitor activating at a predetermined temperature or humidity level to prevent mold formation within the inner chamber.
